(19) United States
(12) Patent Application Publication
(10) Pub. No.: US 2022/0213244 A1
(43) Pub. Date: Jul. 7, 2022

(54) NOVEL DEMULSIFIER

(71) Applicant: Tianjin University, Tianjin (CN)

(72) Inventors: Lin HE, Tianjin (CN); Jun MA, Tianjin (CN); Xingang LI, Tianjin (CN); Hong SUI, Tianjin (CN)

(21) Appl. No.: 17/701,369

(22) Filed: Mar. 22, 2022

Related U.S. Application Data
(63) Continuation of application No. PCT/CN2020/109704, filed on Aug. 18, 2020.

(30) Foreign Application Priority Data
Sep. 24, 2019 (CN) 201910902577.4

(51) Int. Cl. C08F 220/40; B01D 17/04

(52) U.S. Cl. CPC C08F 220/40; B01D 17/047

(57) ABSTRACT

Disclosed is a novel demulsifier, which is prepared by a method comprising the following steps of: dissolving a fatty alcohol polyether in a solvent to formulate a fatty alcohol polyether solution with a certain concentration; adding an organic catalyst and an olefin acid to the fatty alcohol polyether solution to carry out an esterification reaction for a certain period of time at a certain temperature and rotating speed; after the completion of the esterification reaction, adding an initiator to carry out a polymerization reaction for a certain period of time at a certain temperature and rotating speed; and after the completion of the polymerization reaction, evaporating the solvent in the reaction vessel with a rotary evaporator, and then placing the same in a vacuum drying oven and drying for a certain period of time to obtain the novel demulsifier.

### CROSS-REFERENCE TO RELATED APPLICATIONS

This application is a continuation of International Patent Application No. PCT/CN2020/109704 with a filing date of Aug. 18, 2020, designating the United States, now pending, and further claims priority to Chinese Patent Application No. 201910902577.4 with a filing date of Sep. 24, 2019. The content of the aforementioned applications, including any intervening amendments thereto, are incorporated herein by reference.

### TECHNICAL FIELD

The present invention belongs to the field of demulsifiers, and relates to demulsification technologies used for water-in-oil, water-in-heavy oil, oil-in-water and other emulsions, and particularly relates to a novel demulsifier.

### BACKGROUND

With the development of the world's petroleum industry, oil exploitation is increasing day by day, and the world's oil demand is increasing year by year. The gap between oil supply and oil demand in China is also raising annually. Developing and utilizing heavy oil resources such as oil sands, oil shale, oil sludge, and the like, so as to replace some conventional oil, can not only alleviate the energy pressure in China, but also maximize the effective utilization of resources.

However, in the process of heavy oil exploitation, a key problem to be solved is to break the oil-water emulsions. This is because there are natural interfacially active components in the heavy oil that can stabilize the oil-water emulsions, such as resin, asphaltene, naphthenic acid and microcrystalline paraffin. As natural emulsifiers, these substances can stabilize an oil-water two-phase system. Particularly, the high content of resin and asphaltene in heavy oil could form a viscoelastic interfacial film, which can be strongly adsorbed on the surface of water droplets to stabilize the oil-water emulsion. Moreover, the interfacially active substances or other chemical additives that are brought from the exploitation and processing can also adsorb on the oil-water interface and strengthen the emulsification of the oil-water two-phase system, thus making the oil-water system more stable and forming a highly stable oil-water emulsion. The formed oil-water emulsion not only brings great difficulties to the subsequent processing (corrosion of equipment, poisoning of catalyst and increase of transportation cost), but also seriously affects the quality of oil products. Therefore, demulsification and dehydration of the oil-water emulsion need to be carried out to improve the quality of oil and reduce the loss of oil.

To break the stable oil-water two-phase system formed during the processing of heavy oil, that is, to perform demulsification, different methods could be adopted. The most common and effective method in industry is to add chemical agents for demulsification. The added demulsifier molecules penetrate into and adhere to the interface of emulsified water droplets, replacing natural emulsifiers and destroying the oil-water interfacial film. Thus the water droplets aggregate and coalesce to larger ones followed by settling down, resulting in the separation of oil-water two-phase. However, the commercially available conventional demulsifiers in the prior art show poor demulsification effects (long dehydration time and low dehydration efficiency) for the heavy oil-water emulsions system.

### SUMMARY

To overcome the shortcomings of the prior art, the object of the present invention is to provide a demulsifier and a preparation method for separation of a heavy oil-water emulsion system. The prepared demulsifier can realize a rapid and effective demulsification of the heavy oil-water emulsion, and has the characteristics of fast demulsification speed and high dehydration rate.

A technical solution for realizing the object of the present invention is as follows:

A novel demulsifier prepared by a method comprising the following steps of:

1) dissolving a fatty alcohol polyether in an organic solvent to formulate a fatty alcohol polyether solution with a certain concentration;

2) adding an organic catalyst to the fatty alcohol polyether solution in step 1);

3) adding an olefin acid to the solution obtained in step 2) to carry out an esterification reaction;

4) after the completion of the esterification reaction in step 3), adding an initiator to carry out a polymerization reaction; and

5) after the completion of the polymerization reaction in step 4), evaporating the solvent in the product and drying the same to obtain the novel demulsifier.

The fatty alcohol polyether is a linear polyether, and specifically, the initiator is propylene glycol, and reaction monomers of the polyether are ethylene oxide and propylene oxide.

The solvent is an aromatic hydrocarbon solvent, and further, the aromatic hydrocarbon solvent is one or a mixture of more than two of toluene, ethyltoluene, xylene, ethylbenzene and trimethylbenzene.

A ratio of the fatty alcohol polyether monomer to the solvent is 0.1 g to 200 g:100 mL.

In the ratio, a mass fraction of the fatty alcohol polyether monomer in the aromatic hydrocarbon solvent is 0.01% to 70%; a volume ratio of two aromatic hydrocarbon mixed solvents is 0.1 to 10:1, and specifically, a volume ratio of xylene to toluene is 0.1 to 10:1; a volume ratio of three aromatic hydrocarbon mixed solvents is 0.1 to 10:2:1, and specifically, a volume ratio of toluene to trimethylbenzene and ethylbenzene is 0.1 to 10:2:1; a volume ratio of four aromatic hydrocarbon mixed solvents is 0.1 to 10:2:1:1, and specifically, a volume ratio of xylene to ethylbenzene, toluene and trimethylbenzene is 0.1 to 10:2:1:1; a volume ratio of five aromatic hydrocarbon mixed solvents is 0.1 to 10:2:1:1:1, and specifically, a volume ratio of toluene to ethyltoluene, xylene, ethylbenzene and trimethylbenzene is 0.1 to 10:2:1:1:1.

The organic catalyst is sulphonic acid or acetate, and further, the sulphonic acid is aryl sulphonic acid, the organic acid salt is acetate, and still further, the aryl sulphonic acid is benzene sulfonic acid substance, and more specifically one or a mixture of more than two of benzene sulfonic acid, p-toluenesulfonic acid, o-toluenesulfonic acid and m-toluenesulfonic acid. The acetate is more specifically one or a mixture of more than two of zinc acetate, cobaltous acetate, manganous acetate and ferric acetate.

A ratio of the organic catalyst in the reaction accounts for 0.01% to 20% of a mass fraction of the fatty alcohol polyether.

In the ratio, a mass fraction of a single benzene sulfonic acid substance is 0.01% to 20%; a mass ratio of two benzenesulfonic acid substances is 0.1 to 5:1, and specifically, a mass ratio of p-toluenesulfonic acid to o-toluenesulfonic acid is 0.1 to 5:1; a mass ratio of three benzenesulfonic acid substances is 0.1 to 10:2:1, and specifically, a mass ratio of p-toluenesulfonic acid to m-toluenesulfonic acid and benzene sulfonic acid is 0.1 to 10:2:1; a mass fraction of a single acetate is 0.01% to 20%; a mass ratio of two acetates is 0.1 to 10:1, and more specifically, a mass ratio of zinc acetate to cobaltous acetate is 0.1 to 10:1, and a mass ratio of manganous acetate to ferric acetate is 0.1 to 10:1; a mass ratio of three acetates is 0.1 to 10:1:1, and more specifically, a mass ratio of zinc acetate to cobaltous acetate and manganous acetate is 0.1 to 10:1:1, and a mass ratio of cobaltous acetate to manganous acetate and ferric acetate is 0.1 to 10:1:1.

The olefin acid is an olefin acid with carbon atoms of 3 to 20.

Further, the olefin acid is an olefin acid with carbon atoms of 3 to 20 and a molecular weight of 72 g/mol to 283 g/mol.

Still further, the olefin acid is an olefin acid with carbon atoms of 3 to 20 and a molecular weight of 72 g/mol to 283 g/mol, and at least containing one carboxyl.

Specifically, the olefin acid is one or a mixture of more than two of 2-butenoic acid, oleic acid, acrylic acid and undecenoic acid.

A ratio of the olefin acid in the reaction accounts for 0.1% to 30% of a mass fraction of the fatty alcohol polyether.

In the ratio, a mass fraction of a single olefin acid is 0.1% to 30%; a mass ratio of two olefin acids is 0.1 to 8:1, and more specifically, a mass ratio of acrylic acid to 2-butenoic acid is 0.1 to 8:1, and a mass ratio of oleic acid to undecenoic acid is 0.1 to 8:1; a mass ratio of three olefin acids is 0.1 to 15:2:1, and specifically, a mass ratio of acrylic acid to 2-butenoic acid and oleic acid is 0.1 to 15:2:1; and a mass ratio of 2-butenoic acid to oleic acid and undecenoic acid is 0.1 to 15:2:1.

The esterification reaction is performed at a temperature of 80° C. to 170° C.

In the temperature, when a single aromatic hydrocarbon is used as the solvent in the reaction system, the esterification reaction is performed at a temperature of 80° C. to 170° C., and specifically, when xylene is used as the solvent, the temperature is 130° C.; when ethylbenzene is used as the solvent, the temperature is 136° C.; when toluene is used as the solvent, the temperature is 80° C.; and when xylene is used as the solvent, the temperature is 170° C.

When two aromatic hydrocarbons are mixed as the solvent, specifically, xylene and toluene are mixed as the solvent, the temperature is 100° C.; when three aromatic hydrocarbons are mixed as the solvent, specifically, toluene, trimethylbenzene and xylene are mixed as the solvent, the temperature is 120° C.; and when four aromatic hydrocarbons are mixed as the solvent, specifically, xylene, ethylbenzene, toluene and trimethylbenzene are mixed as the solvent, the temperature is 95° C.

The initiator is one or a mixture of more than two of 2,2′-Azobis(2-methylpropionitrile), 2,2′-Azobis-(2,4-dimethylvaleronitrile), benzoyl peroxide, di-tert-butyl peroxide and peroxydicarbonate.

A ratio of the initiator in the reaction accounts for 0.01% to 20% of a mass fraction of the fatty alcohol polyether.

In the ratio, when the selected initiator is any one of the above initiators, the mass fraction is 0.01% to 20%; when the selected initiators are any two of the above initiators, the ratio is 1:1, and specifically, a mass ratio of 2,2′-Azobis(2-methylpropionitrile) to 2,2′-Azobis-(2,4-dimethylvaleronitrile) is 1:1; and a mass ratio of benzoyl peroxide to di-tert-butyl peroxide is 1:1; when the selected initiators are any three of the above initiators, the ratio is 1:1:1, and specifically, a mass ratio of benzoyl peroxide to di-tert-butyl peroxide and peroxydicarbonate is 1:1:1; and a mass ratio of 2,2′-Azobis-(2,4-dimethylvaleronitrile) to benzoyl peroxide and di-tert-butyl peroxide is 1:1:1.

The polymerization reaction is performed at a temperature of 50° C. to 130° C.

In the temperature, when the selected initiator is any one of the above initiators, the polymerization temperature, which is specifically the polymerization temperature corresponding to 2,2′-Azobis(2-methylpropionitrile), 2,2′-Azobis-(2,4-dimethylvaleronitrile), benzoyl peroxide, di-tert-butyl peroxide and peroxydicarbonate, is 50° C. to 130° C.; when the selected initiators are any two of the above initiators, and specifically, when 2,2′-Azobis(2-methylpropionitrile) and 2,2′-Azobis-(2,4-dimethylvaleronitrile) are used as the initiators, the polymerization temperature is 110° C.; and when benzoyl peroxide and di-tert-butyl peroxide are used as the initiators, the polymerization temperature is 120° C.; when the selected initiators are any three of the above initiators, and specifically, when benzoyl peroxide, di-tert-butyl peroxide and peroxydicarbonate are used as the initiators, the polymerization temperature is 125° C.; and when 2,7-Azobis-(2,4-dimethylvaleronitrile), benzoyl peroxide and di-tert-butyl peroxide are used as the initiators, the polymerization temperature is 130° C.

The product is dried at a temperature of 60° C. to 130° C. and a pressure of −0.1 MPa to −0.05 MPa.

The present invention protects application of the demulsifier in separation of emulsion systems such as water-in-oil, water-in-heavy oil.

A specific application method is as follows:

a) dissolving the demulsifier in deionized water to formulate a polyether demulsifier aqueous solution with a certain concentration; and

b) adding a certain volume of the polyether demulsifier aqueous solution in water-in-oil, water-in-heavy oil or oil-in-water emulsion for demulsification.

Compared with the prior art, the present invention has the beneficial effects that: the conditions for preparing the demulsifier are controllable, the preparation process is simple and feasible, a heavy oil-water emulsion which keeps stable for up to one year can be effectively demulsified, the water in the heavy oil-water emulsion system can be completely removed in a short time, the dehydration effect is good, and the demulsification of the existing heavy oil-water emulsion is greatly promoted.

### BRIEF DESCRIPTION OF THE DRAWINGS

To explain the specific embodiments of the present invention more clearly, the drawings needed in the embodiments will be briefly explained below.

FIG. 1 is a general chemical reaction formula of an esterification and a polymerization reaction in embodiments.

FIG. 2 is a photo of a demulsifier prepared in Embodiment 1.

FIG. 3 is a Fourier transform infrared (FTIR) spectrum of a demulsifier prepared in Embodiment 2.

FIG. 4 is a hydrogen nuclear magnetic resonance (¹H-NMR) spectrum of a demulsifier in Embodiment 5.

FIG. 5 is a carbon nuclear magnetic resonance (¹³C-NMR) spectrum of the demulsifier in Embodiment 5.

FIG. 6 is a thermogravimetry (TG) curve of a demulsifier in Embodiment 4.

### DETAILED DESCRIPTION

For the sake of understanding the present invention, the following embodiments are given, but the present invention is not limited thereto. It should be clear to those skilled in the art that the embodiments are only for helping to understand the present invention, and should not be regarded as specific limitations of the present invention.

### Embodiment 1

Preparation of Demulsifier for Separation of Oil-Water Emulsion and Demulsification Test:

Synthesis of demulsifier: at room temperature, 1 g of fatty alcohol polyether was added into a three-necked flask equipped with a thermometer, a stirrer and a reflux condensing tube, and then added with 100 mL of xylene to make the fatty alcohol polyether monomer completely dissolved in xylene under a stirring condition, wherein the concentration of fatty alcohol polyether monomer after being dissolved was 0.01 g/mL. Then, 0.01 g of acrylic acid was added, wherein a mass fraction of p-toluenesulfonic acid was 0.01%. The temperature was gradually raised to 100° C. in an oil bath, and an esterification reaction was carried out for 1.5 h. After the completion of the esterification reaction, benzoyl peroxide was added, wherein a mass fraction of the initiator was 0.01%, and a polymerization reaction was carried out at 105° C. for 1 hour. After the completion of the polymerization reaction, a rotary evaporator was used to evaporate the xylene solvent, and a temperature of the rotary evaporator was set to be 70° C. The obtained liquid was dried under vacuum at a temperature of 95° C. for 20 min to obtain the demulsifier.

The demulsifier prepared in the above process was used for demulsification of a heavy oil-water emulsion, and the demulsification performances of the demulsifier were characterized by the amount of water removed in a certain period of time:

Demulsification test of heavy oil-water emulsion: the demulsifier prepared by the above method was added into a heavy oil-water emulsion containing 10% (volume fraction) of water. The heavy oil-water emulsion was pre-loaded into a graduated cylinder with stopper, and the concentration of the demulsifier was 300 ppm. Then, the cylinder with stopper was placed in a water bath at 70° C., and the amount of water removed was measured every 5 min. A relation between the amount of water removed and the demulsification time within 30 min was given, where the amount of water removed was measured by a volume percentage. In this way, the demulsification performance of the demulsifier for the heavy oil-water emulsion was characterized. See Table 1 for the amount of water removed at different time.

### Embodiment 2

The process of preparing the demulsifier and the demulsification test in this embodiment were similar to those in Embodiment 1, except that: 6 g of fatty alcohol polyether monomer was added, the mass fraction of the organic acid catalyst was 4%, the mass fraction of the initiator was 3%, the esterification reaction lasted for 14 h and the polymerization reaction lasted for 16 h. See Table 1 for the amount of water removed at different time.

### Embodiment 3

The process of preparing the demulsifier and the demulsification test in this embodiment were similar to those in Embodiment 1, except that: 8 g of fatty alcohol polyether monomer was added, the mass fraction of the organic acid catalyst was 10%, the mass fraction of the initiator was 15%, the esterification reaction lasted for 13 h, and the polymerization reaction lasted for 15 h. See Table 1 for the amount of water removed at different time.

### Embodiment 4

The process of preparing the demulsifier and the demulsification test in this embodiment were similar to those in Embodiment 1, except that: 15 g of fatty alcohol polyether monomer was added, the mass fraction of the organic acid catalyst was 15%, the mass fraction of the initiator was 16%, the esterification reaction lasted for 12 h, and the polymerization reaction lasted for 14 h. See Table 1 for the amount of water removed at different time.

### Embodiment 5

The process of preparing the demulsifier and the demulsification test in this embodiment were similar to those in Embodiment 1, except that: 20 g of fatty alcohol polyether monomer was added, the mass fraction of the organic acid catalyst was 17%, the mass fraction of the initiator was 15%, the esterification reaction lasted for 14.8 h, and the polymerization reaction lasted for 16 h. See Table 1 for the amount of water removed at different time.

### Embodiment 6

The process of preparing the demulsifier and the demulsification test in this embodiment were similar to those in Embodiment 1, except that: 35 g of fatty alcohol polyether monomer was added, the mass fraction of the organic acid catalyst was 20%, the mass fraction of the initiator was 20%, the esterification reaction lasted for 24 h, and the polymerization reaction lasted for 24 h. See Table 1 for the amount of water removed at different time.

### Embodiment 7

The process of preparing the demulsifier and the demulsification test in this embodiment were similar to those in Embodiment 1, except that: 5 g of fatty alcohol polyether monomer was added, the olefin acid was a mixture of acrylic acid and 2-butenoic acid with a mass of 0.5 g respectively, the solvent was a mixed solvent of ethyltoluene and toluene with a volume of 50 mL respectively, the organic acid catalyst was a mixture of p-toluenesulfonic acid and o-toluenesulfonic acid with a mass fraction of 0.2% respectively, the esterification reaction was carried out at a temperature of 140° C. and lasted for 4 h, the initiator was a mixture of 2,2′-Azobis(2-methylpropionitrile) and 2,2′-Azobis-(2,4-dimethylvaleronitrile) with a mass fraction of 0.15% respectively, the polymerization reaction was carried out at a temperature of 110° C. and lasted for 6 h, and the concentration of demulsifier was 300 ppm. See Table 1 for the amount of water removed at different time.

### Embodiment 8

The process of preparing the demulsifier and the demulsification test in this embodiment were similar to those in Embodiment 1, except that: 10 g of fatty alcohol polyether monomer was added, the olefin acid was a mixture of acrylic acid, 2-butenoic acid and oleic acid with masses of 0.5 g, 1 g and 0.5 g respectively. The solvent was a mixed solvent of 20 mL of xylene, 40 mL of ethylbenzene, 20 mL of toluene and 20 mL of trimethylbenzene, and the organic acid catalyst was a mixture of p-toluenesulfonic acid, m-toluenesulfonic acid and o-toluenesulfonic acid with mass fractions of 2%, 4% and 2% respectively. The esterification reaction was carried out at a temperature of 95° C. and lasted for 2 h, and the initiator was a mixture of benzoyl peroxide and di-tert-butyl peroxide with a mass fraction of 0.15% respectively. The polymerization reaction was carried out at a temperature of 120° C. and lasted for 4 h, and the concentration of demulsifier was 300 ppm.

See Table 1 for the amount of water removed at different time.

### Embodiment 9

The process of preparing the demulsifier and the demulsification test in this embodiment were similar to those in Embodiment 1, except that: 10 g of fatty alcohol polyether monomer was added, the olefin acid was a mixture of 2-butenoic acid, oleic acid and undecenoic acid with masses of 0.5 g, 1 g and 0.5 g respectively. The solvent was a mixed solvent of 20 mL of xylene, 40 mL of ethylbenzene, 20 mL of toluene and 20 mL of trimethylbenzene, and the organic acid catalyst was a mixture of p-toluenesulfonic acid, m-toluenesulfonic acid and o-toluenesulfonic acid with mass fractions of 2%, 4% and 2% respectively. The esterification reaction was carried out at a temperature of 95° C. and lasted for 2 h, and the initiator was a mixture of benzoyl peroxide and di-tert-butyl peroxide with a mass fraction of 0.15% respectively. The polymerization reaction was carried out at a temperature of 120° C. and lasted for 4 h, and the concentration of demulsifier was 300 ppm.

See Table 1 for the amount of water removed at different time.

### Embodiment 10

The process of preparing the demulsifier and the demulsification test in this embodiment were similar to those in Embodiment 1, except that: 8 g of fatty alcohol polyether monomer was added, the olefin acid was a mixture of oleic acid and undecenoic acid with a mass of 0.6 g respectively, the solvent was a mixed solvent of 25 mL of toluene, 25 mL of ethylbenzene and 50 mL of trimethylbenzene, and the organic acid catalyst was a mixture of zinc acetate, cobaltous acetate and manganous acetate with mass fractions of 2%, 2% and 2% respectively. The esterification reaction was carried out at a temperature of 110° C. and lasted for 3 h, and the initiator was a mixture of benzoyl peroxide, di-tert-butyl peroxide and peroxydicarbonate with a mass fraction of 3% respectively. The polymerization reaction was carried out at a temperature of 125° C. and lasted for 5 h, and the concentration of demulsifier was 300 ppm. See Table 1 for the amount of water removed at different time.

### Embodiment 11

The process of preparing the demulsifier and the demulsification test in this embodiment were similar to those in Embodiment 1, except that: 12 g of fatty alcohol polyether monomer was added, the olefin acid was a mixture of oleic acid and undecanoic acid with a mass of 0.6 g respectively, the solvent was a mixed solvent of xylene and toluene with a volume of 50 mL respectively, the organic acid catalyst was a mixture of p-toluenesulfonic acid and o-toluenesulfonic acid with a mass fraction of 0.2% respectively, the esterification reaction was carried out at a temperature of 170° C. and lasted for 4 h, the initiator was a mixture of 2,2′-Azobis(2-methylpropionitrile) and 2,2′-Azobis-(2,4-dimethylvaleronitrile) with a mass fraction of 0.15% respectively, the polymerization reaction was carried out at a temperature of 110° C. and lasted for 4 h, and the concentration of demulsifier was 300 ppm. See Table 1 for the amount of water removed at different time.

### Embodiment 12

The process of preparing the demulsifier and the demulsification test in this embodiment were similar to those in Embodiment 1, except that: 15 g of fatty alcohol polyether monomer was added, the olefin acid was a mixture of acrylic acid, 2-butenoic acid and oleic acid with masses of 0.75 g, 1.5 g and 0.75 g respectively, the solvent was a mixed solvent of 25 mL of toluene, 50 mL of trimethylbenzene and 25 mL of ethylbenzene, the organic acid catalyst was a mixture of cobaltous acetate, manganous acetate and ferric acetate with a mass fraction of 3% respectively, the esterification reaction was carried out at a temperature of 110° C. and lasted for 4 h, the initiator was a mixture of 2,2′-Azobis-(2,4-dimethylvaleronitrile), benzoyl peroxide and di-tert-butyl peroxide with a mass fraction of 3% respectively, the polymerization reaction was carried out at a temperature of 130° C. and lasted for 4 h, and the concentration of added demulsifier was 300 ppm. See Table 1 for the amount of water removed at different time.

### Comparative Example 1

Commercially available demulsifier polyether AP2040 was used to carry out demulsification test on the heavy oil-water emulsion. The demulsification method and demulsification test conditions were the same as those in Embodiment 1. See Table 1 for the amount of water removed at different time.

### Comparative Example 2

Commercially available demulsifier polyether BP2050 was used to carry out demulsification test on the heavy oil-water emulsion. The demulsification method and demulsification test conditions were the same as those in Embodiment 6. See Table 1 for the amount of water removed at different time.

### Comparative Example 3

Commercially available demulsifier G-D05 was used to carry out demulsification test on the heavy oil-water emulsion. The demulsification method and demulsification test conditions were the same as those in Embodiment 1. See Table 1 for the amount of water removed at different time.

### Comparative Example 4

Commercially available demulsifier G-D07 was used to carry out demulsification test on the heavy oil-water emulsion. The demulsification method and demulsification test conditions were the same as those in Embodiment 6. See Table 1 for the amount of water removed at different time.

### Comparative Example 5

Commercially available demulsifier SP169 was used to carry out demulsification test on the heavy oil-water emulsion. The demulsification method and demulsification test conditions were the same as those in Embodiment 1. See Table 1 for the amount of water removed at different time.

### Comparative Example 6

Commercially available demulsifier PE2040 was used to carry out demulsification test on the heavy oil-water emulsion. The demulsification method and demulsification test conditions were the same as those in Embodiment 1. See Table 1 for the amount of water removed at different time.

### Comparative Example 7

Commercially available demulsifier AE1951 was used to carry out demulsification test on the heavy oil-water emulsion. The demulsification method and demulsification test conditions were the same as those in Embodiment 12. See Table 1 for the amount of water removed at different time.

### Comparative Example 8

Commercially available demulsifier P-125 was used to carry out demulsification test on the heavy oil-water emulsion. The demulsification method and demulsification test conditions were the same as those in Embodiment 1. See Table 1 for the amount of water removed at different time.

### Comparative Example 9

Commercially available demulsifier WJ-46 was used to carry out demulsification test on the heavy oil-water emulsion. The demulsification method and demulsification test conditions were the same as those in Embodiment 1. See Table 1 for the amount of water removed at different time.

### Comparative Example 10

Commercially available demulsifier WJ-44 was used to carry out demulsification test on the heavy oil-water emulsion. The demulsification method and demulsification test conditions were the same as those in Embodiment 12. See Table 1 for the amount of water removed at different time.

### Comparative Example 11

Commercially available demulsifier WJ-11 was used to carry out demulsification test on the heavy oil-water emulsion. The demulsification method and demulsification test conditions were the same as those in Embodiment 1. See Table 1 for the amount of water removed at different time.

### Comparative Example 12

Commercially available demulsifier WJ-714 was used to carry out demulsification test on the heavy oil-water emulsion. The demulsification method and demulsification test conditions were the same as those in Embodiment 1. See Table 1 for the amount of water removed at different time.

Table 1 shows the comparative results of dehydration rates of the demulsifiers in Embodiments 1 to 12 and the demulsifiers in Comparative Examples 1 to 12 for the heavy oil-water emulsion systems at different time.

| | Dehydration rates (%) at different time | | | | | |
|---|---|---|---|---|---|---|
| Examples | 5 min | 10 min | 15 min | 20 min | 25 min | 30 min |
| Embodiment 1 | 32 | 64.1 | 94.8 | 95.2 | 98.9 | 100 |
| Embodiment 2 | 33.1 | 65.7 | 95.3 | 97.2 | 98.9 | 100 |
| Embodiment 3 | 36.2 | 69.7 | 96.8 | 97.5 | 99.2 | 100 |
| Embodiment 4 | 35.8 | 68.3 | 96.8 | 97.2 | 99.4 | 100 |
| Embodiment 5 | 31.8 | 65 | 96 | 98 | 99.7 | 100 |
| Embodiment 6 | 34.6 | 68 | 96 | 98 | 99.5 | 100 |
| Embodiment 7 | 30.8 | 72 | 93 | 94.2 | 97.2 | 100 |
| Embodiment 8 | 32.7 | 69 | 92.7 | 94.7 | 98.2 | 100 |
| Embodiment 9 | 34.6 | 68 | 93 | 95 | 97.8 | 100 |
| Embodiment 10 | 35.5 | 69.8 | 94.8 | 96 | 99 | 100 |
| Embodiment 11 | 33.6 | 71.2 | 94.5 | 95 | 98.4 | 100 |
| Embodiment 12 | 36.5 | 71.8 | 92 | 93 | 97.5 | 100 |
| Comparative | 10 | 15.1 | 20.3 | 28.4 | 30.1 | 30.1 |
| Example 1 | | | | | | |
| Comparative | 5 | 10.1 | 12.1 | 13.4 | 15.6 | 15.6 |
| Example 2 | | | | | | |
| Comparative | 2.1 | 3.2 | 4.3 | 5.1 | 5.1 | 5.1 |
| Example 3 | | | | | | |
| Comparative | 4.2 | 4.8 | 5.5 | 5.5 | 5.6 | 5.6 |
| Example 4 | | | | | | |
| Comparative | 0 | 0 | 0 | 0 | 0 | 0 |
| Example 5 | | | | | | |
| Comparative | 0 | 0 | 0 | 0 | 0 | 0 |
| Example 6 | | | | | | |
| Comparative | 5.5 | 10 | 11.5 | 13 | 14 | 16.5 |
| Example 7 | | | | | | |
| Comparative | 4.5 | 5 | 6.5 | 8.5 | 10 | 12.5 |
| Example 8 | | | | | | |
| Comparative | 0 | 3.5 | 5.5 | 6.5 | 8 | 9.5 |
| Example 9 | | | | | | |
| Comparative | 0 | 3 | 4.5 | 5 | 7 | 8.5 |
| Example 10 | | | | | | |
| Comparative | 0 | 0 | 0 | 0 | 3 | 5 |
| Example 11 | | | | | | |
| Comparative | 0 | 0 | 0 | 3.5 | 4 | 4.5 |
| Example 12 | | | | | | |

As can be seen from Table 1, the demulsifiers of Embodiments 1 to 12 in the present invention have a fast demulsification speed for the water-in-heavy oil emulsion, and can completely realize oil-water separation in 15 min to 30 mini. The dehydration rates of demulsifiers in Embodiments 1 to 12 in the present invention are obviously better than those of Comparative Examples 1 to 12.

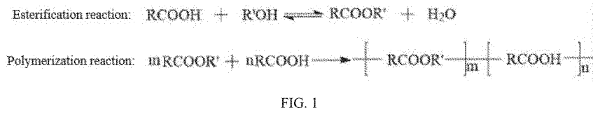

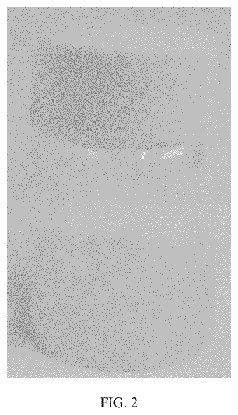

FIG. 2 is a photo of the demulsifier prepared in Embodiment 1. Colors and appearance of the demulsifiers prepared in other embodiments are the same as that in FIG. 1.

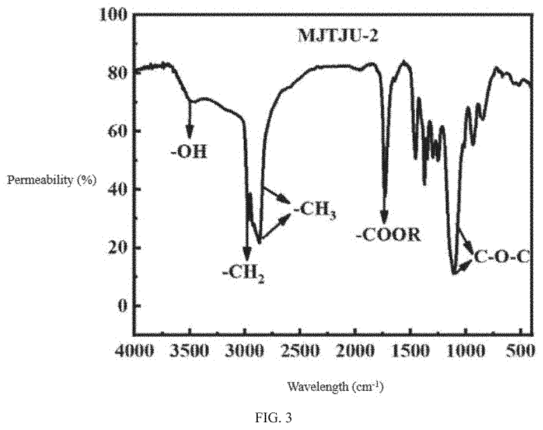

FIG. 3 is a Fourier transform infrared (FTIR) spectrum of the demulsifier prepared in Embodiment 2.

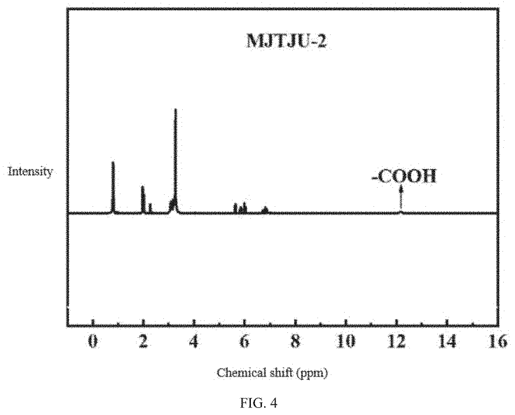

FIG. 4 is a hydrogen nuclear magnetic resonance (¹H-NMR) spectrum of the demulsifier in Embodiment 5.

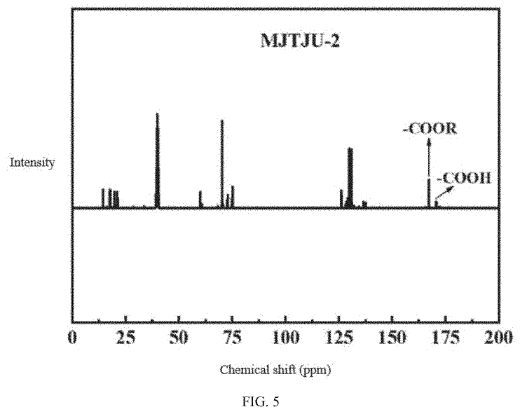

FIG. 5 is a carbon nuclear magnetic resonance (¹³C-NMR) spectrum of the demulsifier in Embodiment 5. By comparing FIG. 3, FIG. 4 and FIG. 5, it can be known that polyether demulsifiers with ester and carboxyl groups are synthesized.

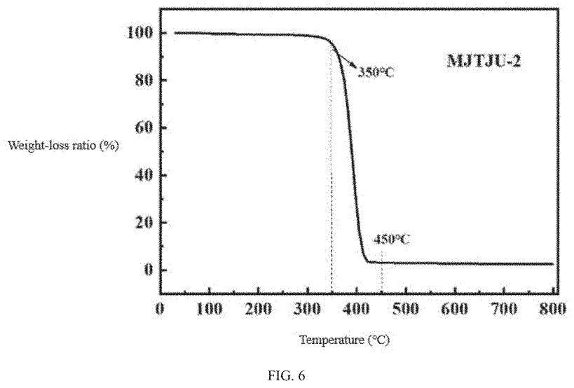

FIG. 6 is a thermogravimetry (TG) curve of the demulsifier in Embodiment 4. The thermogravimetry curve shows that the prepared demulsifier possesses good thermal stability.

It should be finally noted that the present invention provides a preparation method for a heavy oil-water emulsion demulsifier. The above embodiments are only used to illustrate the technical solution of the present invention, rather than limiting the present invention. Although the present invention has been described in detail with reference to the foregoing embodiments, those with ordinary skills in the art should understand that: he can still improve and modify the technical solutions set forth by the above embodiments, or equivalently replace some or all of the technical features. However, these improvements or substitutions do not make the essence of the corresponding technical solutions deviate from the scope of the technical solutions of each embodiment in the present invention.

1. A novel demulsifier prepared by a method comprising the following steps:
i) dissolving a fatty alcohol polyether in an organic solvent to formulate a fatty alcohol polyether solution with a certain concentration;
ii) adding an organic catalyst to the fatty alcohol polyether solution in step i);
iii) adding an olefin acid to the solution obtained in step ii) to carry out an esterification reaction;
iv) after the completion of the esterification reaction in step iii), adding an initiator to carry out a polymerization reaction; and
v) after the completion of the polymerization reaction in step iv), evaporating the solvent in the product and drying the same to obtain the novel demulsifier.

2. The demulsifier according to claim 1, wherein the fatty alcohol polyether is linear, the initiator is propylene glycol, and monomers of polyether are ethylene oxide and propylene oxide.

3. The demulsifier according to claim 1, wherein the solvent is an aromatic hydrocarbon solvent.

4. The demulsifier according to claim 3, wherein the aromatic hydrocarbon solvent is one or a mixture of more than two of toluene, ethyltoluene, xylene, ethylbenzene and trimethylbenzene.

5. The demulsifier according to claim 1, wherein a ratio of the fatty alcohol polyether monomer to the solvent is 0.1 g to 200 g:100 mL.

6. The demulsifier according to claim 1, wherein the organic catalyst is sulphonic acid or organic acid salt.

7. The demulsifier according to claim 6, wherein the sulphonic acid is aryl sulphonic acid; and the organic acid salt is acetate.

8. The demulsifier according to claim 7, wherein the aryl sulphonic acid is one or a mixture of more than two of benzene sulfonic acid, p-toluenesulfonic acid, o-toluenesulfonic acid and m-toluenesulfonic acid; and the acetate is one or a mixture of more than two of zinc acetate, cobaltous acetate, manganous acetate and ferric acetate.

9. The demulsifier according to claim 1, wherein a ratio of the organic catalyst in the reaction accounts for 0.01% to 20% of a mass fraction of the fatty alcohol polyether.

10. The demulsifier according to claim 1, wherein the olefin acid is an olefin acid with carbon atoms of 3 to 20.

11. The demulsifier according to claim 10, wherein the olefin acid is an olefin acid with at least one carboxyl and a molecular weight of 72 g/mol to 300 g/mol.

12. The demulsifier according to claim 11, wherein the olefin acid is one or a mixture of more than two of 2-butenoic acid, oleic acid, acrylic acid and undecenoic acid.

13. The demulsifier according to claim 1, wherein a ratio of the olefin acid in the reaction accounts for 0.1% to 30% of a mass fraction of the fatty alcohol polyether.

14. The demulsifier according to claim 1, wherein the esterification reaction is performed at a temperature of 80° C. to 170° C.

15. The demulsifier according to claim 1, wherein the initiator is one or a mixture of more than two of 2,2′-Azobis(2-methylpropionitrile), 2,2′-Azobis-(2,4-dimethylvaleronitrile), benzoyl peroxide, di-tert-butyl peroxide and peroxydicarbonate.

16. The demulsifier according to claim 1, wherein a ratio of the initiator in the reaction accounts for 0.01% to 20% of a mass fraction of the fatty alcohol polyether.

17. The demulsifier according to claim 1, wherein the polymerization reaction is performed at a temperature of 50° C. to 130° C.

18. The demulsifier according to claim 1, wherein the product is dried at a temperature of 60° C. to 130° C. and a pressure of −0.1 MPa to −0.05 MPa.

19. An application of the demulsifier according to claim 1 in separation of a water-in-oil system, a water-in-heavy oil system and an oil-in-water emulsion system.
